(19) United States
(12) Patent Application Publication
(10) Pub. No.: US 2026/0310846 A1
(43) Pub. Date: Oct. 8, 2026

(54) MODULAR DESIGN METHOD FOR ACTIVE PHASED ARRAY TRANSMITTING ANTENNA FOR MICROWAVE WIRELESS POWER TRANSMISSION

(71) Applicant: Xidian University, Xi’an (CN)

(72) Inventors: Xun LI, Xi’an (CN); Wei WANG, Xi’an (CN); Baoyan DUAN, Xi’an (CN); Yiqun ZHANG, Xi’an (CN); Guangda CHEN, Xi’an (CN); Jianwei MI, Xi’an (CN); Sihao QIAN, Xi’an (CN); Guanheng FAN, Xi’an (CN)

(21) Appl. No.: 19/437,174

(22) Filed: Dec. 30, 2025

(30) Foreign Application Priority Data
Mar. 28, 2025 (CN) 202510384013.1

(51) Int. Cl. G06F 30/20; G06F 111/04; G06F 111/10

(52) U.S. Cl. CPC G06F 30/20; G06F 2101/08; G06F 2101/14; G06F 2111/04; G06F 2111/10

(57) ABSTRACT

A modular design method for an active phased array transmitting antenna for microwave wireless power transmission includes: obtaining an aperture-field amplitude distribution function for a transmitting antenna that maximizes beam collection efficiency under a constraint of a peak radiation level outside a receiving region; designing a physical size and an arrangement mode of subarrays, establishing a radiation model of the subarrays, and obtaining subarray excitation coefficients according to the physical size and the arrangement mode, and the aperture-field amplitude distribution function; categorizing the subarrays based on the subarray excitation coefficients, assigning each category of the subarrays as a module, and calculating module excitation coefficients; and optimizing the module excitation coefficients to maximize beam collection efficiency, and simultaneously suppressing the peak radiation level outside the receiving region radiated by the radiation model.

### CROSS-REFERENCE TO RELATED APPLICATION

This application claims priority to Chinese Patent Application No. 202510384013.1, filed on Mar. 28, 2025, which is herein incorporated by reference in its entirety.

### TECHNICAL FIELD

The disclosure relates to the technical field of antenna design, and more particularly to a modular design method for an active phased array transmitting antenna for microwave wireless power transmission.

### BACKGROUND

Microwave wireless power transmission is a technology that transmits electrical energy in a microwave form to a target region via a transmitting antenna, and then captures and reconverts the microwave energy back into the electrical energy by using a receiving rectenna at the target region, which has broad application prospects. The microwave wireless power transmission enables convenient power supply to regions where cable installation is difficult, such as disaster zones, large offshore platforms, islands, and remote mountainous regions. The microwave wireless power transmission also provides flexible power for mobile targets like satellite platforms, unmanned aerial vehicles, and airships. Active phased array antennas have flexible beam shaping and steering capabilities, which are considered the preferred choice for microwave wireless power transmission transmitting antennas. However, if each radiating element of an active phased array antenna is connected to a separate transmit component, the cost becomes prohibitively high, which hinders the widespread adoption of the microwave wireless power transmission technology. Modular design can significantly reduce the number and variety of the transmit components required, which serves as one means to lower the cost of the active phased array transmitting antennas. Therefore, researching a modular design method for an active phased array transmitting antenna for microwave wireless power transmission holds significant engineering application value.

Currently, domestic and international research on microwave wireless power transmission transmitting antenna design primarily follows these approaches. (1) An excitation amplitude of each radiating element of the transmitting antenna is optimized to achieve the highest beam collection efficiency. For the active phased array antennas, if each radiating element is connected to a transmit component with different output power, the engineering implementation becomes difficult and the cost is high. (2) The transmitting antenna is partitioned into regular subarrays with uniform excitation for all subarrays to reduce costs. However, since all subarrays are uniformly excited, the beam collection efficiency is relatively low, thereby affecting the power transmission efficiency of the system. (3) Irregular subarrays are adopted, and subarray excitation coefficients are optimized to improve the beam collection efficiency. The feeding network for the irregular subarrays is complex, which makes engineering implementation challenging.

Cost and efficiency are two key metrics for evaluating microwave wireless power transmission systems. In practical engineering, designing a transmitting antenna requires simultaneous consideration of both efficiency and cost factors. Therefore, there is a need to propose a design method for active phased array transmitting antennas that achieves both high efficiency and low cost.

### SUMMARY

In order to solve technical problems of low efficiency and high cost in microwave wireless energy transmission in the related art, the disclosure provides a modular design method for an active phased array transmitting antenna for microwave wireless power transmission. The adopted technical solutions are as follows.

A modular design method for an active phased array transmitting antenna for microwave wireless power transmission includes:
S1, obtaining an aperture-field amplitude distribution function of a transmitting antenna;
S2, designing a physical size and an arrangement mode of subarrays, establishing a radiation model of the subarrays, and obtaining subarray excitation coefficients for the subarrays according to the physical size and the arrangement mode of the subarrays, and the aperture-field amplitude distribution function;
S3, categorizing the subarrays based on the subarray excitation coefficients to obtain multiple categories, assigning each of the multiple categories as a module to thereby obtain multiple modules corresponding to the multiple categories, and calculating module excitation coefficients for the multiple modules;
S4, optimizing the module excitation coefficients to maximize beam collection efficiency, and simultaneously suppressing a peak radiation level outside a receiving region radiated by the radiation model.

In an exemplary embodiment, the modular design method for an active phased array transmitting antenna for microwave wireless power transmission further includes:
S5, loading optimized module excitation coefficients into a feed network of the transmitting antenna to excite corresponding subarrays, such that the active phased array transmitting antenna generates a focused beam with maximum beam collection efficiency while satisfying a radiation safety constraint outside the receiving region, and transmits microwave energy to a receiving antenna.

In an embodiment of the disclosure, the step S1 includes:
S11, determining a normalized aperture-field amplitude distribution function Eₜ(ρ, ψ) of the transmitting antenna;
S12, determining a beam collection efficiency function BCE;
S13, obtaining the aperture-field amplitude distribution function ƒ(ρ) of the transmitting antenna, and obtaining a transmitting antenna aperture-field distribution that maximizes the beam collection efficiency and maximum beam collection efficiency;
S14, determining an aperture-field field distribution design of the transmitting antenna without considering a constraint of the peak radiation level outside the receiving region; and
S15, considering the constraint of the peak radiation level outside the receiving region, suppressing the peak radiation level outside the receiving region and achieving a high beam collection efficiency.

In an embodiment of the disclosure, the step S11 includes:
letting Eₜ(ρ, ψ) as the normalized aperture-field amplitude distribution function of the transmitting antenna, wherein Eₜ(ρ, ψ) is expressed through a formula (1) as follows:

$${E}_{t} ( ρ , ψ ) = f ( ρ ) exp [ j ψ ( ρ ) ] \qquad ( 1 )$$

where in the formula (1), ƒ(ρ) represents the aperture-field amplitude distribution function of the transmitting antenna, ψ(ρ) represents a phase distribution function of the transmitting antenna, ρ=r/Rₜ represents a normalized radius of the transmitting antenna, r represents a distance from a center of the transmitting antenna to any point on an aperture surface of the transmitting antenna;
where in a Fresnel region, to focus transmitted beams on a receiving aperture-field surface at a distance L, the transmitting antenna is configured to have a spherical phase distribution:

$$ψ ( ρ ) = k {ρ}^{2} {R}_{t}^{2} / ( 2 L ) ;$$

and k represents a wave constant, and k=2π/λ.

In an embodiment of the disclosure, in step S12, the beam collection efficiency is a ratio of a microwave power focused by the transmitting antenna on the receiving antenna to a total radiated power of the transmitting antenna, and the beam collection efficiency is expressed through a formula (2) as follows:

$$B C E = \frac{{\int }_{o}^{{u}_{0}} {F}^{2} ( u ) u d u}{{\int }_{0}^{1} {f}^{2} ( ρ ) ρ d ρ} \qquad ( 2 )$$

in the formula (2),

$$F ( u ) = {\int }_{0}^{1} f ( ρ ) {J}_{0} ( u ρ ) ρ d ρ \qquad ( 3 )$$

where in the formula (2) and a formula (3), BCE represents the beam collection efficiency, J₀(·) represents a zero-order Bessel function of a first kind, u=kRₜ sin θ, sin θ≈r′/L, r′ represents a distance from a center of the receiving antenna to any point on an aperture surface of the receiving antenna, u₀=kRₜ sin θ₀≈kRₜRᵣ/L, and θ₀ represents a viewing angle of the transmitting antenna towards the receiving antenna.

In an embodiment of the disclosure, the step S13 includes:
determining a number of basis functions for describing the aperture-field amplitude distribution function ƒ(ρ), and expressing the aperture-field amplitude distribution function ƒ(ρ) of the transmitting antenna through a formula (4) as follows:

$$f ( ρ ) = {\sum }_{n = 1}^{N} {{x}_{n} ( 1 - {ρ}^{2} )}^{n - 1} \qquad ( 4 )$$

where in the formula (4), (1-ρ²)ⁿ⁻¹ represents a basis function, and xₙ represents a control coefficient;
letting x=[x₁, . . . , x_{N}]^{T}, and A=[1, . . . , (1-ρ²)^{N-1}]^{T} thus, the formula (4) is expressed through a formula (5) as follows:

$$f ( ρ ) = {x}^{T} A \qquad ( 5 )$$

where in the formula (5), a superscript T represents matrix transpose;
substituting the formula (5) into a denominator of the formula (2) to obtain a formula (6) as follows:

$${\int }_{0}^{1} {f}^{2} ( ρ ) ρ d ρ = {x}^{T} D x \qquad ( 6 )$$

in the formula (6),

$${D}_{m n} = \frac{1}{2 ( m + n - 1 )} \qquad ( 7 )$$

substituting the formula (4) into the formula (3) to obtain a formula (8) of F(u) as follows:

$$F ( u ) = {\sum }_{n = 1}^{N} {x}_{n} {\int }_{0}^{1} {( 1 - {ρ}^{2} )}^{n - 1} {J}_{0} ( u ρ ) ρ d ρ \qquad ( 8 )$$

where a n^{th} integral in the formula (8) is expressed through a formula (9) as follows:

$${\int }_{0}^{1} {( 1 - {ρ}^{2} )}^{n - 1} {J}_{0} ( u ρ ) ρ d ρ = \frac{{2}^{n - 1} ( n - 1 ) ! {J}_{n} ( u )}{{u}^{n}} \qquad ( 9 )$$

where in the formula (9), Jₙ(·) represents a n^{th}-order Bessel function of the first kind, and !represents denotes factorial;
letting

$$B = {[ \frac{{J}_{1} ( u )}{u} , … , \frac{{2}^{N - 1} ( N - 1 ) ! {J}_{N} ( u )}{{u}^{N}} ]}^{T}$$

rewrite the formula (8) to obtain a formula (10) as follows:

$$F ( u ) = {x}^{T} B \qquad ( 10 )$$

where based on the formula (10), a numerator of the formula (2) is expressed through a formula (11) as follows:

$${\int }_{o}^{{u}_{0}} {F}^{2} ( u ) udu = {x}^{T} Cx \qquad ( 11 )$$

in the formula (11),

$${C}_{mn} = {\int }_{0}^{{u}_{0}} \frac{{2}^{m - 1} ( m - 1 ) ! {J}_{m} ( u )}{{u}^{m}} \cdot \frac{{2}^{n - 1} ( n - 1 ) ! {J}_{n} ( u )}{{u}^{n}} udu \qquad ( 12 )$$

substituting the formula (11) and the formula (6) into the formula (2) to obtain a formula (13) as follows:

$$BCE = \frac{{x}^{T} Cx}{{x}^{T} Dx} \qquad ( 13 )$$

obtaining, based on the formula (13), the transmitting antenna aperture-field distribution that maximizes the beam collection efficiency by determining an optimal coefficient vector x^{opt} which is expressed as follows:

$${x}^{opt} = arg [ {max}_{x} ( \frac{{x}^{T} Cx}{{x}^{T} Dx} ) ] ; \qquad ( 14 )$$

determining, through a matrix C and a matrix D, a corresponding maximum eigenvalue λₘₐₓ and a corresponding eigenvector through a formula (15) as follows:

$${Cx}^{opt} = {λ}_{max} {Dx}^{opt} \qquad ( 15 )$$

where in the formula (15), the maximum beam collection efficiency is equal to λₘₐₓ, and a corresponding optimal aperture-field amplitude distribution is ƒ(ρ)=(x^{opt})^{T}A.

In an embodiment of the disclosure, in the step S14, the peak radiation level outside the receiving region is expressed through a formula (16) as follows:

$$PRL = 20 {log}_{10} \frac{{max}_{u \geq {u}_{0}} \vert F ( u ) \vert}{{max}_{u} \vert F ( u ) \vert} \qquad ( 16 )$$

where in the formula (16), PRL represents the peak radiation level outside the receiving region;
where an aperture-field distribution design problem of the transmitting antenna is transformed through a formula (17) as follows:

$${min}_{x} \cdot g ( x ) = - BCE ( x ) \qquad ( 17 )$$

$$s . t . PRL ( x ) \leq {C}_{0}$$

$$- 1 \leq {x}_{i} \leq 1 ( i = 1 , … , N )$$

where in the formula (17), C₀ represents a maximum allowable radiation level outside the receiving region; and
without the constraint of the peak radiation level outside the receiving region, maximizing the beam collection efficiency, and obtaining the corresponding optimal aperture-field amplitude distribution and the radiation pattern.

In an embodiment of the disclosure, the step S15 includes:
incorporating the constraint on the peak radiation level outside the receiving region directly into an objective function to transform into an unconstrained optimization problemed through a formula (18) as follows:

$$f ( x ) = - BCE ( x ) + \text{?} \cdot [ max ( 0 , PRL ( x ) - {C}_{0} ) ] \qquad ( 18 )$$

where in the formula (18), K represents a penalty parameter configured to control influence of a penalty term; and
suppressing the peak radiation level outside the receiving region and achieving the high beam collection efficiency.

In an embodiment of the disclosure, the step S2 includes:
for the transmitting antenna with an aperture size of Rₜ, obtaining, based on the aperture-field amplitude distribution function ƒ(ρ) of the transmitting antenna, a p^{th} subarray excitation coefficient located at a position (xₚ, yₚ) of the subarray excitation coefficients through a formula (19) expressed as follows:

$${I}_{p} = f ( \frac{\sqrt{{x}_{p}^{2} + {y}_{p}^{2}}}{{R}_{t}} ) \qquad ( 19 )$$

where in the formula (19), ƒ(·) represents the aperture-field amplitude distribution function ƒ(ρ).

In an embodiment of the disclosure, the step S3 includes:
categorizing, based on an excitation coefficient matching principle and the subarray excitation coefficients, the subarrays into Q categories through a formula (20) expressed as follows:

$${min}_{R , {I}^{sub}} {\vert R \cdot {I}^{sub} - {I}^{ref} \vert}^{2} \qquad ( 20 )$$

where in the formula (20), I^{ref}=[I₁, I₂, . . . , I_{P}]^{T} represents reference subarray excitation coefficients, a p^{th} element in I^{ref} is obtained by the formula (19), and P represents a number of the subarrays contained by the transmitting antenna;

$${I}^{sub} = {[ {I}_{1}^{sub} , {I}_{2}^{sub} , … , {I}_{Q}^{sub} ]}^{T}$$

represents the module excitation coefficients, Q represents a number of the multiple modules, R represents a matrix with P rows and Q columns, and Rₚq represents a relationship between a p^{th} subarray and a q^{th} module, satisfying:

$${R}_{pq} = \{ \begin{matrix}1 & if subarray p ∈ module q \\ 0 & if subarray p ∉ module q\end{matrix} ; and \qquad ( 21 )$$

$${\sum }_{q = 1}^{Q} {R}_{pq} = 1 , ( p = 1 , 2 , … P ) ; \qquad ( 22 )$$

where an excitation coefficient of the q^{th} module is expressed through a formula (23) as follows:

$${I}_{q}^{sub} = \frac{{\sum }_{p = 1}^{P} {R}_{pq} {I}_{p}}{{\sum }_{p = 1}^{P} {R}_{pq}} ; \qquad ( 23 )$$

and
solving, by using a k-means clustering method, the formula (20) to obtain an optimal module partitioning scheme, and obtaining, according to the formula (23), each of the module excitation coefficients.

In an embodiment of the disclosure, the step S4 includes:
expressing, based on the optimal module partitioning scheme of the step S3, a radiation pattern of the transmitting antenna through a formula (24) expressed as follows:

$$F ( u , v ) = {\sum }_{p = 1}^{P} {\sum }_{q = 1}^{Q} {R}_{p q} {I}_{q}^{s u b} {E}_{p} ( θ , φ ) {e}^{j k ( u {x}_{p} + v {y}_{p} )} \qquad ( 24 )$$

where in the formula (24), Eₚ(θ, φ) represents a radiation pattern of the p^{th} subarray, u=sin θ cos φ, and v=sin θ sin φ, and u and v represent direction cosines;
where the beam collection efficiency and the peak radiation level outside the receiving region are respectively expressed through a formula (25) and a formula (26) expressed as follows:

$$B C E = \frac{{P}_{Ψ}}{{P}_{Ω}} = \frac{{\int }_{0}^{2 π} {\int }_{0}^{{θ}_{0}} {\vert F ( u , v ) \vert}^{2} sin θ d θ d φ}{{\int }_{0}^{2 π} {\int }_{0}^{π} {\vert F ( u , v ) \vert}^{2} sin θ d θ d φ} \qquad ( 25 )$$

$$PRL = 20 {log}_{10} \frac{{max}_{r \geq {r}_{0}} \vert F ( u , v ) \vert}{max \vert F ( u , v ) \vert} \qquad ( 26 )$$

where in the formula (26), r=\sqrt{u²+v²}, r₀=sin θ₀, and θ₀ represents a viewing angle of the transmitting antenna towards a receiving antenna;
where an optimization model is expressed as follows:

$${min}_{{I}^{s u b}} . - BCE ( {I}^{s u b} )$$

$$s . t . PRL ( {I}^{s u b} ) \leq {C}_{0} ; \qquad ( 27 )$$

optimizing, by using a grey wolf optimizer (GWO) algorithm, the module excitation coefficients to improve the beam collection efficiency, and simultaneously constraining the peak radiation level outside the receiving region.

Beneficial effects of the disclosure are as follows.

The modular design method for the active phased array transmitting antenna for microwave wireless power transmission provided by the disclosure first designs the aperture-field amplitude distribution function of the transmitting antenna aiming at maximizing the beam collection efficiency (BCE), then obtains the subarray excitation coefficients, subsequently partitions the subarrays into modules, and calculates the module excitation coefficients. By optimizing the module excitation coefficients, the BCE is maximized while simultaneously suppressing the peak radiation level (PRL) outside the receiving region radiated by the radiation model. Through module partitioning, the disclosure enables performance of the transmitting array to closely approximate that of a continuous aperture-field. After optimizing the module excitation coefficients, it not only increases the maximum BCE but also suppresses the PRL. Therefore, by concurrently considering both the beam collection efficiency and the safety aspect related to radiation outside the receiving region, the disclosure reduces the engineering implementation difficulty and manufacturing cost of the transmitting antenna while satisfying high transmission efficiency, effectively enabling the design of active phased array transmitting antennas with high BCE, high safety, and low cost.

### BRIEF DESCRIPTION OF DRAWINGS

FIG. 1 illustrates a flowchart of a modular design method for an active phased array transmitting antenna for microwave wireless power transmission according to an embodiment of the disclosure.

FIG. 2 illustrates a schematic diagram of normalized aperture-field amplitude distributions with and without PRL constraints according to an embodiment of the disclosure.

FIG. 3 illustrates a schematic diagram of antenna normalized radiation patterns corresponding to the aperture-field amplitude distributions given in FIG. 2 according to an embodiment of the disclosure.

FIG. 4 illustrates a schematic diagram of a 2×2 patch element subarray according to an embodiment of the disclosure.

FIG. 5 illustrates a schematic diagram of a substrate integrated coaxial line (SICL) structure according to an embodiment of the disclosure.

FIG. 6 illustrates a schematic structural diagram of an optimized 2×2 subarray according to an embodiment of the disclosure.

FIG. 7 illustrates a schematic diagram of a simulated S11 curve for the designed 2×2 subarray according to an embodiment of the disclosure.

FIG. 8 illustrates a schematic diagram of an axial ratio (AR) curve for the designed 2×2 subarray according to an embodiment of the disclosure.

FIG. 9 illustrates a schematic diagram of gain for the designed 2×2 subarray according to an embodiment of the disclosure.

FIG. 10 illustrates a schematic diagram of a transmitting array with a diameter of 2.3 meters (m) according to an embodiment of the disclosure.

FIG. 11 illustrates a schematic diagram of optimal module partitioning layouts for (a) Q=2, (b) Q=3, and (c) Q=4 modules without a PRL constraint according to an embodiment of the disclosure.

FIG. 12A illustrates a schematic diagram of a 5×5 array according to an embodiment of the disclosure.

FIG. 12B illustrates a schematic diagram of a gain pattern of an embedded element pattern (EEP) for the 2×2 patch subarray according to an embodiment of the disclosure.

FIG. 13 illustrates a schematic diagram of optimal module partitioning layouts for (a) Q=2, (b) Q=3, and (c) Q=4 modules with the PRL constraint according to an embodiment of the disclosure.

### DETAILED DESCRIPTION OF EMBODIMENTS

The disclosure is described in detail in conjunction with drawings and embodiments below.

The disclosure provides a modular design method for a high-efficiency, low-cost active phased array transmitting antenna used in microwave wireless power transmission, which can reduce engineering implementation difficulty and manufacturing cost of the transmitting antenna while satisfying high transmission efficiency requirements.

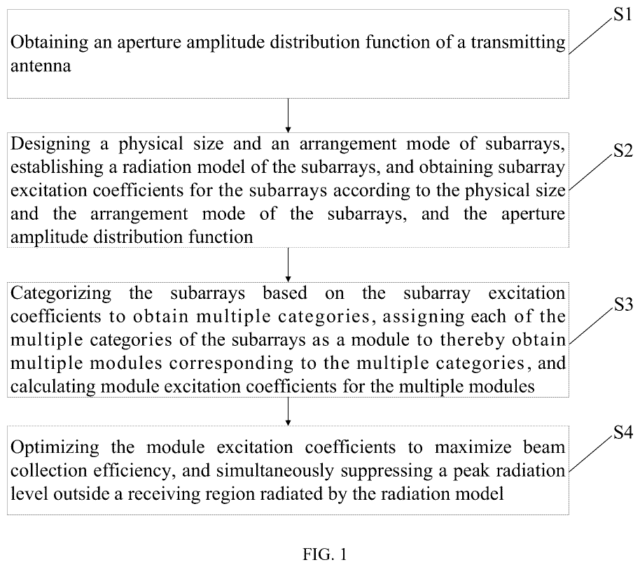

Referring to FIG. 1, the modular design method for an active phased array transmitting antenna for microwave wireless power transmission of the disclosure includes the following steps S1-S4.

In step S1, an aperture-field amplitude distribution function of a transmitting antenna is obtained.

In step S2, a physical size and an arrangement mode of subarrays are designed. A radiation model of the subarrays is established. Subarray excitation coefficients for the subarrays are obtained according to the physical size and the arrangement mode of the subarrays, and the aperture-field amplitude distribution function.

In step S3, the subarrays are categorized based on the subarray excitation coefficients to obtain multiple categories, each category of the subarrays is assigned as a module to thereby obtain multiple modules corresponding to the multiple categories, and module excitation coefficients for the multiple modules are calculated.

In step S4, the module excitation coefficients are optimized to maximize beam collection efficiency, and a peak radiation level outside a receiving region radiated by the radiation model is simultaneously suppressed.

The step S1 of the disclosure includes the following steps S11-S15.

In step S11, a normalized aperture-field amplitude distribution function Eₜ(ρ, ψ) of the transmitting antenna is determined.

Let Eₜ(ρ, ψ) as the normalized aperture-field amplitude distribution function of the transmitting antenna, which is expressed through a formula (1) as follows:

$${E}_{t} ( ρ , ψ ) = f ( ρ ) exp [ j ψ ( ρ ) ] \qquad ( 1 )$$

where in the formula (1), ƒ(ρ) represents the aperture-field amplitude distribution function of the transmitting antenna, ψ(ρ) represents a phase distribution function of the transmitting antenna, ρ=r/Rₜ represents a normalized radius of the transmitting antenna, r represents a distance from a center of the transmitting antenna to any point on an aperture surface of the transmitting antenna.

In a Fresnel region, to focus transmitted beams on a receiving aperture-field surface at a distance L, the transmitting antenna is configured to have a spherical phase distribution:

$$ψ ( ρ ) = k {ρ}^{2} {R}_{t}^{2} / ( 2 L ) ;$$

and k represents a wave constant, and k=2π/λ, where λ represents an operating wavelength.

In step S12, a beam collection efficiency function BCE is determined.

The beam collection efficiency is a ratio of a microwave power focused by the transmitting antenna on the receiving antenna to a total radiated power of the transmitting antenna, which is expressed through a formula (2) as follows:

$$B C E = \frac{{\int }_{o}^{{u}_{0}} {F}^{2} ( u ) u d u}{{\int }_{0}^{1} {f}^{2} ( ρ ) ρ d ρ} \qquad ( 2 )$$

in the formula (2),

$$F ( u ) = {\int }_{0}^{1} f ( ρ ) {J}_{0} ( u ρ ) ρ d ρ \qquad ( 3 )$$

where in the formula (2) and a formula (3), BCE represents the beam collection efficiency, J₀(·) represents a zero-order Bessel function of a first kind, u=kRₜ sin θ, sin θ≈r′/L, r′ represents a distance from a center of the receiving antenna to any point on an aperture surface of the receiving antenna, u₀=kRₜ sin θ₀≈kRₜRᵣ/L, and θ₀ represents a viewing angle of the transmitting antenna towards the receiving antenna.

In step S13, the aperture-field amplitude distribution function ƒ(ρ) of the transmitting antenna is obtained, and a transmitting antenna aperture-field distribution that maximizes the beam collection efficiency and maximum beam collection efficiency are obtained.

A number of basis functions for describing the aperture-field amplitude distribution function ƒ(ρ) is determined, and the aperture-field amplitude distribution function ƒ(ρ) of the transmitting antenna is expressed through a formula (4) as follows:

$$f ( ρ ) = {\sum }_{n = 1}^{N} {{x}_{n} ( 1 - {ρ}^{2} )}^{n - 1} \qquad ( 4 )$$

where in the formula (4), (1-ρ²)ⁿ⁻¹ represents a basis function, and xₙ represents a control coefficient.

Let x=[x₁, . . . , x_{N}]^{T}, and A=[1, . . . , (1-ρ²)^{N-1}]^{T}, thus, formula (4) is expressed through a formula (5) as follows:

$$f ( ρ ) = {x}^{T} A \qquad ( 5 )$$

where in the formula (5), a superscript T represents matrix transpose.

The formula (5) is substituted into a denominator of the formula (2) to obtain a formula (6) as follows:

$${\int }_{0}^{1} {f}^{2} ( ρ ) ρ d ρ = {x}^{T} D x \qquad ( 6 )$$

in formula (6),

$${D}_{m n} = \frac{1}{2 ( m + n - 1 )} . \qquad ( 7 )$$

The formula (4) is substituted into the formula (3) to obtain a formula (8) of F(u) as follows:

$$F ( u ) = {\sum }_{n = 1}^{N} {x}_{n} {\int }_{0}^{1} {( 1 - {ρ}^{2} )}^{n - 1} {J}_{0} ( u ρ ) ρ d ρ . \qquad ( 8 )$$

A n^{th} integral in the formula (8) is expressed through a formula (9) as follows:

$${\int }_{0}^{1} {( 1 - {ρ}^{2} )}^{n - 1} {J}_{0} ( u ρ ) ρ d ρ = \frac{{2}^{n - 1} ( n - 1 ) ! {J}_{n} ( u )}{{u}^{n}} \qquad ( 9 )$$

where in the formula (9), Jₙ(·) represents a n^{th} order Bessel function of the first kind, and !represents denotes factorial.

Let

$$B = {[ \frac{{J}_{1} ( u )}{u} , … , \frac{{2}^{N - 1} ( N - 1 ) ! {J}_{N} ( u )}{{u}^{N}} ]}^{T}$$

to rewrite the formula (8) to obtain a formula (10) as follows:

$$F ( u ) = {x}^{T} B . \qquad ( 10 )$$

Based on the formula (10), a numerator of the formula (2) is expressed through a formula (11) as follows:

$${\int }_{o}^{{u}_{0}} {F}^{2} ( u ) u d u = {x}^{T} C x \qquad ( 11 )$$

in formula (11),

$${C}_{m n} = {\int }_{0}^{{u}_{0}} \frac{{2}^{m - 1} ( m - 1 ) ! {J}_{m} ( u )}{{u}^{m}} \cdot \frac{{2}^{n - 1} ( n - 1 ) ! {J}_{n} ( u )}{{u}^{n}} udu . \qquad ( 12 )$$

The formula (11) and the formula (6) are substituted into the formula (2) to obtain a formula (13) as follows:

$$B C E = \frac{{x}^{T} C x}{{x}^{T} D x} . \qquad ( 13 )$$

Based on the formula (13), the transmitting antenna aperture-field distribution that maximizes the beam collection efficiency is obtained and expressed as determining an optimal coefficient vector x^{opt}, which is expressed as follows:

$${x}^{opt} = arg [ {max}_{x} ( \frac{{x}^{T} c x}{{x}^{T} D x} ) ] . \qquad ( 14 )$$

Through a matrix C and a matrix D, a corresponding maximum eigenvalue λₘₐₓ and a corresponding eigenvector are determined and expressed through a formula (15) as follows:

$$C {x}^{opt} = {λ}_{max} D {x}^{opt} \qquad ( 15 )$$

where in the formula (15), the maximum beam collection efficiency is equal to λₘₐₓ, and a corresponding optimal aperture-field amplitude distribution is ƒ(ρ)=(x^{opt})^{T}A.

In step S14, an aperture-field field distribution design problem of the transmitting antenna is determined without considering a constraint of the peak radiation level outside the receiving region.

For some microwave wireless power transmission (MWPT) applications, the transmitted power is very high. Therefore, radiation safety must be considered, that is, the peak radiation level outside the receiving region must be taken into account.

The peak radiation level outside the receiving region is expressed through a formula (16) as follows:

$$P R L = 20 {log}_{10} \frac{{max}_{u \geq {u}_{0}} \vert F ( u ) \vert}{{max}_{u} \vert F ( u ) \vert} \qquad ( 16 )$$

where in the formula (16), PRL represents the peak radiation level outside the receiving region.

The aperture-field distribution design problem of the transmitting antenna is transformed through a formula (17) into follows:

$${min}_{x} . g ( x ) = - B C E ( x ) \qquad ( 17 )$$

$$s . t . PRL ( x ) \leq {C}_{0}$$

$$- 1 \leq {x}_{i} \leq 1 ( i = 1 , … , N )$$

where in the formula (17), C₀ represents a maximum allowable radiation level outside the receiving region; and without the constraint of the peak radiation level outside the receiving region, the beam collection efficiency is maximized and the corresponding optimal aperture-field amplitude distribution and the radiation pattern are obtained.

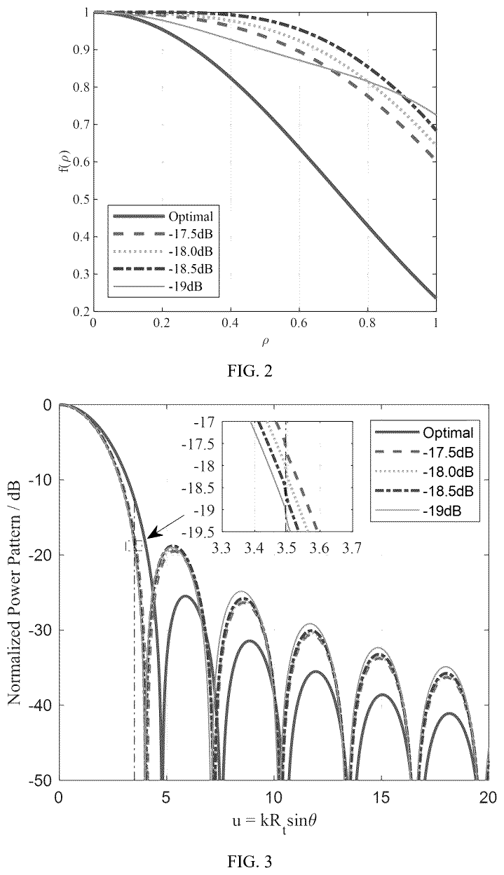

Specifically, in the embodiment, for the constrained optimization problem of the aperture-field distribution design of the transmitting antenna, without the PRL constraint, by solving the eigenvalue problem in the formula (15), the maximum BCE is obtained. The schematic diagrams of the optimal aperture-field amplitude distribution and power pattern are shown in FIG. 2 (solid line) and FIG. 3 (thick solid line), respectively, where the black dotted line indicates an edge of the receiving aperture-filed. It is observed that a relatively high PRL (PRL=−12.58 decibel, abbreviated as dB) occurs at the edge of the receiving aperture-filed. Such a high PRL may pose problems for the environment or human safety.

In step S15, the constraint of the peak radiation level outside the receiving region is considered, the peak radiation level outside the receiving region is suppressed, and a high beam collection efficiency is achieved.

Due to potential environmental or human safety concerns from high PRL, it is necessary to constrain the peak radiation level outside the receiving region. In order to further handle this constrained optimization problem, the PRL constraint is directly incorporated into the objective function, and transformed into an unconstrained optimization problem, which is expressed through a formula (18) as follows:

$$f ( x ) = - B C E ( x ) + ℵ \cdot [ max ( 0 , PRL ( x ) - {C}_{0} ) ] \qquad ( 18 )$$

where in the formula (18), K represents a penalty parameter configured to control influence of a penalty term.

The optimization problem is processed by using a powerful grey wolf optimizer-Nelder-mead (GWO-NM) algorithm, the peak radiation level outside the receiving region is suppressed, and the high beam collection efficiency is achieved.

In the embodiment, the penalty parameter is set as 10⁶, and a threshold of the PRL is set as C₀=−17.5 dB. The embodiment uses the GWO-NM algorithm to obtain BCE and the corresponding PRL. The optimized control coefficient vector x^{opt} is shown in the third row, and second column of Table 2. The optimal aperture-field amplitude distribution is ƒ(ρ)=(x^{opt})^{T}A, where A=[1, . . . , (1-ρ²)^{N-1}]^{T} The corresponding schematic diagrams of the optimal aperture-field amplitude distribution and radiation pattern are shown in FIG. 2 (dashed line) and FIG. 3 (dashed line), respectively.

In an embodiment, in the embodiment, in order to better reduce the PRL, the threshold of the PRL is continuously updated. The GWO-NM algorithm is used to obtain the maximum BCE under different threshold constraints. Multiple sets of maximum BCE/PRL threshold pairs are compared, to reveal a relationship between maximizing BCE and suppressing PRL under different thresholds. The optimized aperture-field amplitude distribution function ƒ(ρ) is ultimately determined by ensuring maximum BCE while suppressing the PRL value.

In an optional embodiment, the step S2 includes the following steps.

Based on actual engineering requirements, such as an operating frequency and a bandwidth of the antenna, physical dimensions (e.g., length, width, or diameter) of each subarray are designed. A layout of the subarrays is designed according to the application scenario (e.g., radar, communication). Common layout methods include rectangular grid, triangular grid, and circular array.

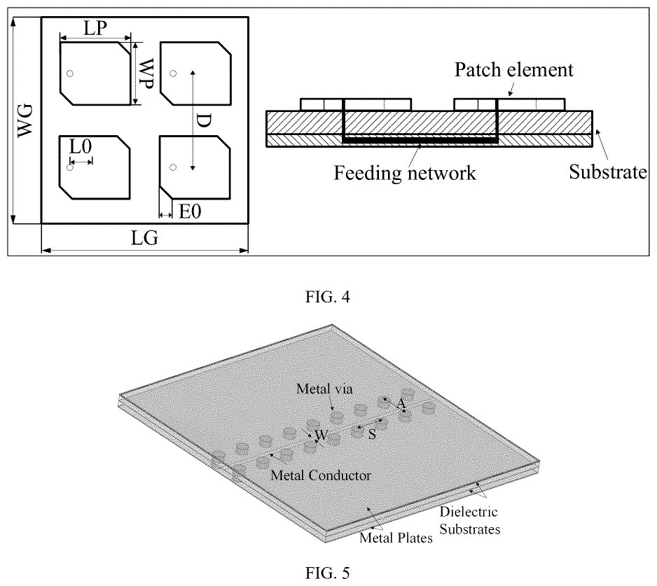

In the embodiment, patch antennas are adopted due to their small size, low profile, and ease of integration. Here, LP and WP represent a length and a width of the patch, respectively. LG and WG represent a length and a width of a substrate, respectively. L0 represents a distance from a patch center to a feed point. E0 represents a size of cut edges. D represents a distance between two adjacent patches. It is noted that circular polarization is achieved for the subarray by cutting the patch edges. The subarray structure design is shown in FIG. 4.

Simultaneously, based on a mutual coupling effect between array subarrays, the embodiment uses a SICL technology to design the feed network. The SICL structure consists of five layers from top to bottom, as shown in FIG. 4. The first and fifth layers are metal plates, the second and fourth layers are dielectric substrates, and the third layer contains metal conductors and connecting dielectric. The schematic diagram of the SICL structure is shown in FIG. 5, where W represents a width of the metal conductor, S represents a distance between metal vias, and A represents a distance between the metal vias on both sides of the conductor.

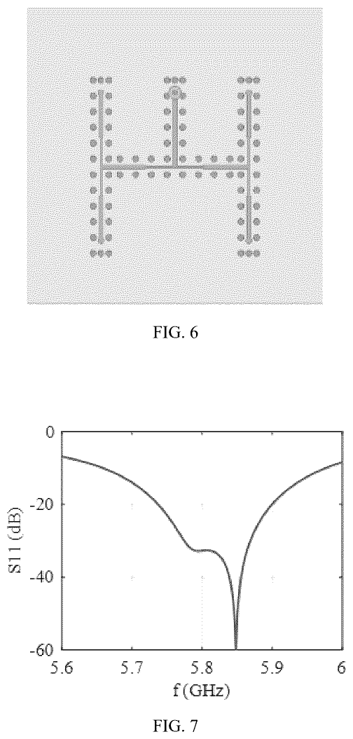

In order to fully utilize non-scanning characteristics of the array, a spacing between two adjacent units is set to 47 millimeters (mm, approximately 0.9λ), which is relatively large compared to the wavelength. FIG. 6 illustrates the optimized 2×2 subarray structure.

Based on the designed subarray structure, a simulation software is used to establish a radiation model of the subarrays and calculate its element factor. The element factor describes the radiation pattern characteristics of a single subarray and forms the basis for subsequent array factor calculations.

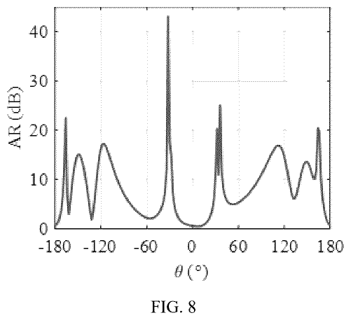

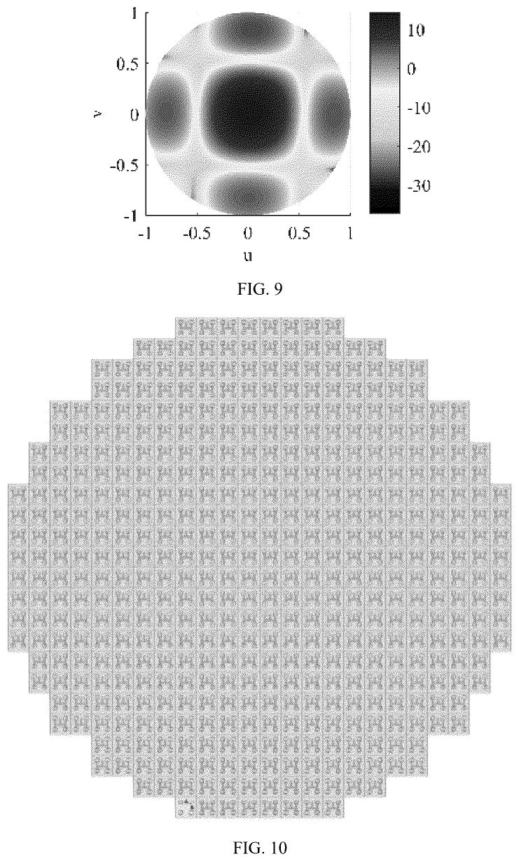

In the embodiment, based on the designed subarray structure, the radiation model of the subarray is established. The simulated S11 curve is shown in FIG. 7, the AR curve is shown in FIG. 8, and the realized gain pattern is shown in FIG. 9.

Typically, it is difficult to design an aperture-field antenna with a specific aperture radiation. Therefore, in the disclosure, the aperture-field amplitude continuous distribution function ƒ(ρ) is sampled and discretized to obtain excitation coefficients for a circular antenna array composed of subarrays (i.e., repeating radiation units), which can approximate the performance of an aperture antenna.

In the embodiment, the designed subarray is used as the repeating unit, a circular array antenna with a diameter of 2.3 m is constructed, which consists of 464 subarrays, as shown in FIG. 10.

For the transmitting antenna with an aperture size Rₜ (i.e., an array with radius Rₜ), a p^{th} subarray excitation coefficient located at a position (xₚ, yₚ) of the subarray excitation coefficients is obtained through a formula (19) expressed as follows:

$${I}_{p} = f ( \frac{\sqrt{{x}_{p}^{2} + {y}_{p}^{2}}}{{R}_{t}} ) \qquad ( 19 )$$

where in the formula (19), ƒ(·) represents the aperture-field amplitude distribution function ƒ(ρ).

In an optional embodiment, the step S3 includes the following steps.

Each subarray excitation coefficient can be calculated according to the aperture-filed amplitude distribution function ƒ(ρ), the subarray structure and the large array structure. The subarrays are categorized into Q categories based on an excitation coefficient matching principle and the subarray excitation coefficients, which is expressed through a formula (20) as follows:

$${min}_{R , {I}^{sub}} {\vert R \cdot {I}^{s u b} - {I}^{r e f} \vert}^{2} \qquad ( 20 )$$

where in the formula (20), I^{ref}=[I₁, I₂, . . . , I_{P}]^{T} represents reference subarray excitation coefficients, a p^{th} element in I^{ref} is obtained by the formula (19), and P represents a number of the subarrays contained by the transmitting antenna.

$${I}^{s u b} = {[ {I}_{1}^{s u b} , {I}_{2}^{s u b} , … , {I}_{Q}^{s u b} ]}^{T}$$

represents the module excitation coefficients, Q represents a number of the multiple modules, R represents a matrix with P rows and Q columns, and R_{pq} represents a relationship between a p^{th} subarray and a q^{th} module, satisfying:

$${R}_{pq} = \{ \begin{matrix}1 & if subarray p ∈ module q \\ 0 & if subarray p ∉ module q\end{matrix} ; \qquad ( 21 )$$

$${\sum }_{q = 1}^{Q} {R}_{p q} = 1 , ( p = 1 , 2 , … , P ) . \qquad ( 22 )$$

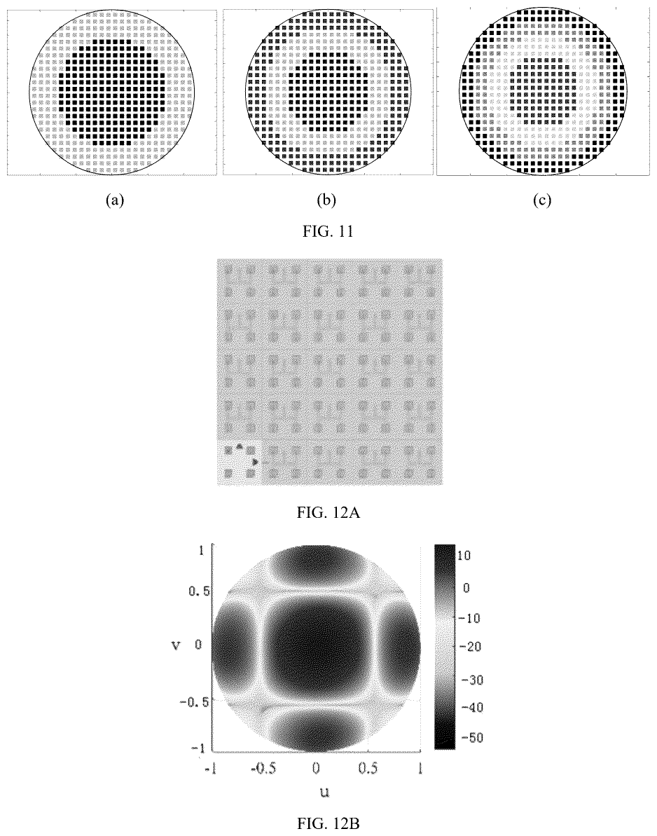

Specifically, in the embodiment, the optimal ƒ(ρ) that yields the maximum BCE without the PRL constraint is first considered. Meanwhile, in order to study the relationship between achievable BCE and the number of modules, the embodiment sets different numbers of modules: (a) Q=2, (b) Q=3, and (c) Q=4. A k-means clustering method is used to obtain the optimal module partitioning results (i.e., the target module partitioning scheme) as shown in FIG. 11, where blocks with the same color form one module.

Specifically, in the embodiment, for simplicity, an excitation coefficient of the module q (i.e., q^{th} module) is approximately expressed through a formula (23) as follows:

$${I}_{q}^{s u b} = \frac{{\sum }_{p = 1}^{P} {R}_{p q} {I}_{p}}{{\sum }_{p = 1}^{P} {R}_{p q}} . \qquad ( 23 )$$

The k-means clustering method is used to solve the formula (20) to obtain the optimal module partitioning scheme, and then each module excitation coefficient is obtained according to the formula (23).

It should be noted that to accurately estimate the performance of the large array, such as BCE and PRL, mutual coupling effects need to be considered. However, analyzing this large array by using a full-wave simulator is very time-consuming. Therefore, the embodiment adopts an embedded element pattern (EEP) method to simulate the modular large array, i.e., using a 5×5 array as shown in FIG. 12A; and considering the coupling effects of adjacent elements, the embedded element gain pattern is plotted as shown in FIG. 12B.

The radiation pattern of the array can be approximated by multiplying the array factor with the EEP through a formula (28) expressed as follows:

$$F ( u , v ) = E E P ( θ , φ ) {\sum }_{p = 1}^{P} {\sum }_{q = 1}^{Q} {R}_{p q} {I}_{q}^{s u b} {e}^{j k ( u {x}_{p} + v {y}_{p} )} . \qquad ( 28 )$$

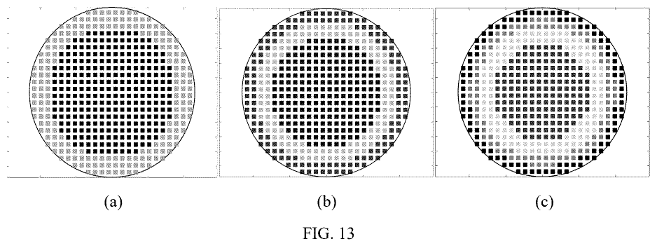

It is worth noting that the 3D radiation pattern of the transmitting array mentioned above is obtained without considering the PRL constraint outside the receiving region. However, the PRL values obtained from the three array module partitioning schemes are very high, which is not ideal in practical engineering. Therefore, the optimized amplitude distribution with PRL constraint given in step S15 is used. Specifically, in the embodiment, the constrain PRL: C₀=−18.5 dB is used as an example, to obtain the optimal module partitioning result as shown in FIG. 13.

In an optional embodiment, the step S4 includes the follows.

Based on the optimal module partitioning scheme of the step S3, a radiation pattern of the transmitting antenna is expressed through a formula (24) as follows:

$$F ( u , v ) = {\sum }_{p = 1}^{P} {\sum }_{q = 1}^{Q} {R}_{p q} {I}_{q}^{s u b} {E}_{p} ( θ , φ ) {e}^{j k ( u {x}_{p} + v {y}_{p} )} \qquad ( 24 )$$

where in the formula (24), Eₚ(θ, φ) represents a radiation pattern of the p^{th} subarray, u=sin θ cos φ, and v=sin θ sin φ, u and v represent direction cosines, j represents an imaginary unit, and k represents a wave constant.

Correspondingly, the beam collection efficiency and the peak radiation level outside the receiving region are respectively expressed through a formula (25) and a formula (26) expressed as follows:

$$BCE = \frac{{P}_{Ψ}}{{P}_{Ω}} = \frac{{\int }_{0}^{2 π} {\int }_{0}^{{θ}_{0}} {\vert F ( u , v ) \vert}^{2} sin θ d θ d φ}{{\int }_{0}^{2 π} {\int }_{0}^{π} {\vert F ( u , v ) \vert}^{2} sin θ d θ d φ} \qquad ( 25 )$$

$$PRL = 20 {log}_{10} \frac{{max}_{r \geq {r}_{0}} \vert F ( u , v ) \vert}{max \vert F ( u , v ) \vert} \qquad ( 26 )$$

where in the formula (26), r=\sqrt{u²+v²}, r₀=sin θ₀, and θ₀ represents a viewing angle of the transmitting antenna towards a receiving antenna; and P_{Ψ} represents a microwave power focused by the transmitting antenna on the receiving antenna, and P_{Ω} represents a total radiated power of the transmitting antenna.

When the module partitioning is given, both BCE and PRL are determined by the module excitation coefficients. Due to the use of subarrays, the spacing between two adjacent subarrays is relatively large compared to the wavelength, which introduces sampling errors. The module partitioning design of the disclosure further exacerbates these sampling errors.

Therefore, the GWO algorithm is used to optimize the module excitation coefficients, thereby improving the beam collection efficiency while simultaneously constraining the peak radiation level outside the receiving region. The optimization model is expressed as follows:

$${min .}_{{I}^{sub}} - BCE ( {I}^{sub} ) ; \qquad ( 27 )$$

$$s . t . PRL ( {I}^{sub} ) \leq {C}_{0}$$

Specifically, in the embodiment, optimization is performed only for the module partitioning result obtained under the PRL constraint: C₀=−18.5 dB in the step S3, the GWO algorithm is used to optimize the module excitation coefficients and improve the BCE.

The disclosure first provides a low-cost, high-efficiency modular design method for active phased array transmitting antennas for microwave wireless power transmission. Specifically, the method offers three advantages. First, based on the method, the number of transmit modules required for the transmitting antenna is reduced to one-quarter of that required by traditional methods. Second, using the method, the variety of transmit module types required is greatly reduced (e.g., two or three types). Third, the method can simultaneously consider both the beam collection efficiency and the safety factor related to radiation outside the receiving region.

In an embodiment, the modular design method for the active phased array transmitting antenna for microwave wireless power transmission and its effectiveness are explained through specific simulation experiments.

### 1. Simulation Parameters

A fixed point-to-point microwave wireless power transmission (MWPT) system with circular transmitting and receiving antennas is used. The aperture sizes of the transmitting and receiving antennas are Dₜ=2.3 m and Dᵣ=5.0 m, respectively, a distance between the transmitting and receiving antennas is L=100 m, and the operating frequency is 5.8 GHz. Table 1 summarizes the MWPT system parameters.

TABLE 1

| | |
|---|---|
| f (GHz) | 5.8 |
| Dₜ (m) | 2.3 |
| Dᵣ (m) | 5.0 |
| L (m) | 100 |

### 2. Simulation Content and Results

First, simulations are performed for continuous aperture-field distributions with and without PRL constraints are designed. The results are shown in Table 2.

TABLE 2

| PRL constraint | x^{opt} | BCE (%) | PRL (dB) |
|---|---|---|---|
| / | [−0.5341, −1.0000, −0.5605, −0.1510, −0.0236, −0.0030] | 94.48 | −12.58 |
| C₀ = −17.5 dB | [−0.5411, −0.4397, −0.0033, 0.0635, 0.0182, 0.0043] | 90.00 | −17.50 |
| C₀ = −18.0 dB | [1.0000, 0.7946, −0.2011, 0.3140, −0.5543, 0.2020] | 89.29 | −18.00 |
| C₀ = −18.5 dB | [−0.8898, −0.7093, 0.4145, −0.7485, 1.0000, −0.3686] | 88.58 | −18.50 |
| C₀ = −19.0 dB | [1.0000, 0.4197, −0.2160, −0.0258, 0.1175, 0.0839] | 87.76 | −19.00 |

Without PRL constraint, a maximum BCE of 94.48% is obtained, but the peak radiation level outside the receiving region is PRL=−12.58 dB. Furthermore, by adding PRL constraints C₀=−17.5 dB, C₀=−18.0 dB, C₀=−18.5 dB, and C₀=−19.0 dB, the optimized BCE values are 90.0%, 89.29%, 88.58%, and 87.76%, respectively, with the corresponding PRL exactly equal to the constraint values. The obtained excitation coefficients x^{opt} are listed in the second column of Table 2. The continuous aperture-field amplitude distributions and radiation patterns for the above parameter settings are shown in FIGS. 2 and 3. The results show that suppressing PRL comes at the cost of reducing BCE, and as the PRL value decreases, the main lobe becomes narrower and other sidelobes become higher.

Secondly, based on actual engineering requirements, the subarray structure is determined. Patch antennas are used to design a 2×2 patch element subarray, see FIG. 4. The mutual coupling effect between array subarrays is considered, the embodiment of the disclosure uses the SICL technology to design the feed network. Simultaneously, in order to fully utilize the non-scanning characteristics of the array, the spacing between two adjacent units is set to 47 mm (approximate to 0.9λ). The optimized 2×2 subarray structure is shown in FIG. 6, with relevant parameters listed in Table 3.

TABLE 3

| LP | WP | L0 | WG | LG |
|---|---|---|---|---|
| 16.39 mm | 16 mm | 3.59 mm | 94 mm | 94 mm |

| E0 | W | S | A | D |
|---|---|---|---|---|
| 2.4 mm | 1.4 mm | 5 mm | 5 mm | 47 mm |

Thirdly, based on the subarray excitation coefficient calculation formula, each subarray excitation coefficient is obtained. Combined with the excitation coefficient matching principle, the subarrays are categorized into Q categories. Setting (a) Q=2, (b) Q=3, and (c) Q=4, and using the k-means clustering method with PRL constraint (C₀=−18.5 dB) and without PRL constraint, the optimal module partitioning results and related parameters are obtained as shown in Table 4.

TABLE 4

| | Number of | | | |
|---|---|---|---|---|
| | modules | I^{sub} | BCE (%) | PRL (dB) |
| Without PRL | 2 | [0.5030, 1.0000]^{T} | 88.60 | −14.44 |
| constraint | 3 | [0.3981, 0.6855, | 90.95 | −13.44 |
| | | 1.0000]^{T} | | |
| | 4 | [0.3479, 0.5356, | 91.91 | −13.27 |
| | | 0.7581, 1.0000]^{T} | | |
| C₀ = −18.5 dB | 2 | [0.8187, 1.0000]^{T} | 84.98 | −17.86 |
| | 3 | [0.7753, 0.8996, | 85.80 | −18.16 |
| | | 1.0000]^{T} | | |
| | 4 | [0.7454, 0.8423, | 86.15 | −18.29 |
| | | 0.9305, 1.0000]^{T} | | |

The optimal module partitioning results are shown in FIGS. 11 and 13.

Analysis of the results shows that without the PRL constraint, the PRL values for all three module partitioning schemes are very high. By comparing the performance metrics of the discrete arrays in Table 4 with those of the continuous aperture-field in Table 2, as the number of modules increases, the performance of the transmitting array increasingly approaches that of the continuous aperture-field. From FIGS. 11 and 13, it can be seen that the radiated power is mainly concentrated in the receiving region, and the grating lobes are effectively suppressed.

Finally, the PRL values for the aforementioned three module partitioning schemes are higher than −18.5 dB. The continuous distribution can reduce the PRL below −18.5 dB since it avoids the module partitioning and sampling errors. Therefore, the GWO algorithm is used to optimize the module excitation coefficients (with PRL constraint: C₀=−18.5 dB). The results are shown in Table 5.

TABLE 5

| Number of | | | |
|---|---|---|---|
| modules | I^{sub} | BCE (%) | PRL (dB) |
| 3 | [0.7334, 0.8433, 1.0000]^{T} | 86.72 | −18.51 |
| 4 | [0.6773, 0.8507, 0.9015, 1.0000]^{T} | 87.00 | −18.50 |

It is emphasized that when using two modules, the −18.5 dB PRL constraint could not be met. Comparing the results in Tables 4 and 5, the achievable BCE values are increased by 0.92% and 0.87%, respectively, and the PRL values are all reduced below −18.5 dB. This achieves an increase in the maximum BCE while simultaneously suppressing the PRL. The results demonstrate that the method of the disclosure can effectively design active phased array transmitting antennas with high BCE, high safety, and low cost.

The above description is only specific embodiments of the disclosure, but a scope of protection of the disclosure is not limited thereto. Within a technical scope disclosed in the disclosure, any those skilled in the art can easily think of changes or substitutions, which should be covered within the scope of protection of the disclosure. Therefore, the scope of protection of the disclosure should be subject to a scope of protection of claims.

What is claimed is:

1. A modular design method for an active phased array transmitting antenna for microwave wireless power transmission, comprising:
S1, obtaining an aperture-field amplitude distribution function of a transmitting antenna;
S2, designing a physical size and an arrangement mode of subarrays, establishing a radiation model of the subarrays, and obtaining subarray excitation coefficients for the subarrays according to the physical size and the arrangement mode of the subarrays, and the aperture-field amplitude distribution function;
S3, categorizing the subarrays based on the subarray excitation coefficients to obtain multiple categories, assigning each of the multiple categories as a module to thereby obtain multiple modules corresponding to the multiple categories, and calculating module excitation coefficients for the multiple modules; and
S4, optimizing the module excitation coefficients to maximize beam collection efficiency, and simultaneously suppressing a peak radiation level outside a receiving region radiated by the radiation model;
wherein the step S2 comprises:
for the transmitting antenna with an aperture size of Rₜ, obtaining, based on the aperture-field amplitude distribution function ƒ(ρ) of the transmitting antenna, a p^{th} subarray excitation coefficient located at a position (xₚ, yₚ) of the subarray excitation coefficients through a formula (19) expressed as follows: 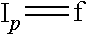
wherein in the formula (19), ƒ(·) represents the aperture-field amplitude distribution function ƒ(ρ);
wherein the step S3 comprises:
categorizing, based on an excitation coefficient matching principle and the subarray excitation coefficients, the subarrays into Q categories through a formula (20) expressed as follows:
$${min}_{R , {I}^{sub}} {\vert R \cdot {I}^{s u b} - {I}^{ref} \vert}^{2} \qquad ( 20 )$$
wherein in the formula (20), I^{ref}=[I₁, I₂, . . . , I_{P}]^{T} represents reference subarray excitation coefficients, a p^{th} element in I^{ref} is obtained by the formula (19), and P represents a number of the subarrays contained by the transmitting antenna;
$${I}^{s u b} = {[ {I}_{1}^{s u b} , {I}_{2}^{s u b} , … , {I}_{Q}^{s u b} ]}^{T}$$
represents the module excitation coefficients, Q represents a number of the multiple modules, R represents a matrix with P rows and Q columns, and R_{pq} represents a relationship between a p^{th} subarray and a q^{th} module, satisfying:
$${R}_{p q} = \{ \begin{matrix}1 & if subarray p ∈ module q \\ 0 & if subarray p ∉ module q\end{matrix} ; \qquad ( 21 )$$
$$and$$
$${\sum }_{q = 1}^{Q} {R}_{p q} = 1 , ( p = 1 , 2 , … , P ) ; \qquad ( 22 )$$
wherein an excitation coefficient of the q^{th} module is expressed through a formula (23) as follows:
$${I}_{q}^{s u b} = \frac{{\sum }_{p = 1}^{P} {R}_{p q} {I}_{p}}{{\sum }_{p = 1}^{P} {R}_{p q}} ; \qquad ( 23 )$$
solving, by using a k-means clustering method, the formula (20) to obtain an optimal module partitioning scheme, and obtaining, according to the formula (23), each of the module excitation coefficients; and
wherein the step S4 comprises:
expressing, based on the optimal module partitioning scheme of the step S3, a radiation pattern of the transmitting antenna through a formula (24) expressed as follows:
$$F ( u , v ) = {\sum }_{p = 1}^{P} {\sum }_{q = 1}^{Q} {R}_{p q} {I}_{q}^{s u b} {E}_{p} ( θ , φ ) {e}^{j k ( u {x}_{p} + v {y}_{p} )} \qquad ( 24 )$$
wherein in the formula (24), Eₚ(θ, φ) represents a radiation pattern of the p^{t}h subarray, u=sin θ cos φ, v=sin θ sin φ, and u and v represent direction cosines;
wherein the beam collection efficiency and the peak radiation level outside the receiving region are respectively expressed through a formula (25) and a formula (26) expressed as follows:
$$B C E = \frac{{P}_{Ψ}}{{P}_{Ω}} = \frac{{\int }_{0}^{2 π} {\int }_{0}^{{θ}_{0}} {\vert F ( u , v ) \vert}^{2} sin θ d θ d φ}{{\int }_{0}^{2 π} {\int }_{0}^{π} {\vert F ( u , v ) \vert}^{2} sin θ d θ d φ} \qquad ( 25 )$$
$$PRL = 20 {log}_{10} \frac{{max}_{r \geq {r}_{0}} \vert F ( u , v ) \vert}{max \vert F ( u , v ) \vert} \qquad ( 26 )$$
wherein in the formula (26), r=u²+v², r₀=sin θ₀, and θ₀ represents a maximum viewing angle of the transmitting antenna towards a receiving antenna;
wherein an optimization model is expressed as follows:
$${min .}_{{I}^{sub}} - BCE ( {I}^{sub} ) ; \qquad ( 27 )$$
$$s . t . PRL ( {I}^{sub} ) \leq {C}_{0}$$
and
optimizing, by using a grey wolf optimizer (GWO) algorithm, the module excitation coefficients to improve the beam collection efficiency, and simultaneously constraining the peak radiation level outside the receiving region.

2. The modular design method for the active phased array transmitting antenna for microwave wireless power transmission as claimed in claim 1, wherein the step S1 comprises:
S11, determining a normalized aperture-field amplitude distribution function Eₜ(ρ, ψ) of the transmitting antenna;
S12, determining a beam collection efficiency function BCE;
S13, obtaining the aperture-field amplitude distribution function ƒ(ρ) of the transmitting antenna, and obtaining a transmitting antenna aperture-field distribution that maximizes the beam collection efficiency and maximum beam collection efficiency;
S14, determining an aperture-field distribution design problem of the transmitting antenna without considering a constraint of the peak radiation level outside the receiving region; and
S15, considering the constraint of the peak radiation level outside the receiving region, suppressing the peak radiation level outside the receiving region and achieving high beam collection efficiency.

3. The modular design method for the active phased array transmitting antenna for microwave wireless power transmission as claimed in claim 2, wherein the step S11 comprises:
letting Eₜ(ρ, ψ) as the normalized aperture-field amplitude distribution function of the transmitting antenna, wherein Eₜ(ρ, ψ) is expressed through a formula (1) as follows:
$${E}_{t} ( ρ , ψ ) = f ( ρ ) exp [ j ψ ( ρ ) ] \qquad ( 1 )$$
wherein in the formula (1), ƒ(ρ) represents the aperture-field amplitude distribution function of the transmitting antenna, ψ(ρ) represents a phase distribution function of the transmitting antenna, ρ=r/Rₜ represents a normalized radius of the transmitting antenna, r represents a distance from a center of the transmitting antenna to any point on an aperture surface of the transmitting antenna;
wherein in a Fresnel region, to focus transmitted beams on a receiving aperture surface at a distance L, the transmitting antenna is configured to have a spherical phase distribution:
$$ψ ( ρ ) = k {ρ}^{2} {R}_{t}^{2} / ( 2 L ) ;$$

4. The modular design method for the active phased array transmitting antenna for microwave wireless power transmission as claimed in claim 3, wherein, in step S12, the beam collection efficiency is a ratio of a microwave power focused by the transmitting antenna on the receiving antenna to a total radiated power of the transmitting antenna, and the beam collection efficiency is expressed through a formula (2) as follows:
$$B C E = \frac{{\int }_{0}^{{u}_{0}} {F}^{2} ( u ) u d u}{{\int }_{0}^{1} {f}^{2} ( ρ ) ρ d ρ} \qquad ( 2 )$$
in the formula (2),
$$F ( u ) = {\int }_{0}^{1} f ( ρ ) {J}_{0} ( u ρ ) ρ d ρ \qquad ( 3 )$$
wherein in the formula (2) and a formula (3), BCE represents the beam collection efficiency, J₀(·) represents a zero-order Bessel function of a first kind, u=kRₜ sin θ, sin θ ≈r′/L, r′ represents a distance from a center of the receiving antenna to any point on an aperture surface of the receiving antenna, u₀=kRₜ sin θ₀≈kRₜRᵣ/L, and θ₀ represents a viewing angle of the transmitting antenna towards the receiving antenna.

5. The modular design method for the active phased array transmitting antenna for microwave wireless power transmission as claimed in claim 4, wherein the step S13 comprises:
determining a number of basis functions for describing the aperture-field amplitude distribution function ƒ(ρ), and expressing the aperture-field amplitude distribution function ƒ(ρ) of the transmitting antenna through a formula (4) as follows:
$$f ( ρ ) = {\sum }_{n = 1}^{N} {{x}_{n} ( 1 - {ρ}^{2} )}^{n - 1} \qquad ( 4 )$$
wherein in the formula (4), (1-ρ²)ⁿ⁻¹ represents a basis function, and xₙ represents a control coefficient;
letting x=[x₁, . . . , x_{N}]^{T}, and A=[1, . . . , (1-ρ²)^{N-1}]^{T} to make the formula (4) expressed through a formula (5) as follows:
$$f ( ρ ) = {x}^{T} A \qquad ( 5 )$$
wherein in the formula (5), a superscript T represents matrix transpose;
substituting the formula (5) into a denominator of the formula (2) to obtain a formula (6) as follows:
$${\int }_{0}^{1} {f}^{2} ( ρ ) ρ d ρ = {x}^{T} D x \qquad ( 6 )$$
in the formula (6),
$${D}_{m n} = \frac{1}{2 ( m + n - 1 )} \qquad ( 7 )$$
substituting the formula (4) into the formula (3) to obtain a formula (8) of F(u) as follows:
$$F ( u ) = {\sum }_{n = 1}^{N} {x}_{n} {\int }_{0}^{1} {( 1 - {ρ}^{2} )}^{n - 1} {J}_{0} ( u ρ ) ρ d ρ \qquad ( 8 )$$
wherein a n^{th} integral in the formula (8) is expressed through a formula (9) as follows:
$${\int }_{0}^{1} {( 1 - {ρ}^{2} )}^{n - 1} {J}_{0} ( u ρ ) ρ d ρ = \frac{{2}^{n - 1} ( n - 1 ) ! {J}_{n} ( u )}{{u}^{n}} \qquad ( 9 )$$
wherein in the formula (9), Jₙ(·) represents a n^{th}-order Bessel function of the first kind, and !represents denotes factorial;
letting
$$B = {[ \frac{{J}_{1} ( u )}{u} , … , \frac{{2}^{N - 1} ( N - 1 ) ! {J}_{N} ( u )}{{u}^{N}} ]}^{T}$$
to rewrite the formula (8) to obtain a formula (10) as follows:
$$F ( u ) = {x}^{T} B \qquad ( 10 )$$
wherein based on the formula (10), a numerator of the formula (2) is expressed through a formula (11) as follows:
$${\int }_{0}^{{u}_{0}} {F}^{2} ( u ) u d u = {x}^{T} C x \qquad ( 11 )$$
in the formula (11),
$${C}_{m n} = {\int }_{0}^{{u}_{0}} \frac{{2}^{m - 1} ( m - 1 ) ! {J}_{m} ( u )}{{u}^{m}} \cdot \frac{{2}^{n - 1} ( n - 1 ) ! {J}_{n} ( u )}{{u}^{n}} u d u \qquad ( 12 )$$
substituting the formula (11) and the formula (6) into the formula (2) to obtain a formula (13) as follows:
$$BCE = \frac{{x}^{T} C x}{{x}^{T} D x} \qquad ( 13 )$$
obtaining, based on the formula (13), the transmitting antenna aperture-field distribution that maximizes the beam collection efficiency by determining an optimal coefficient vector x^{opt} wherein the optimal coefficient vector x^{opt} is expressed as follows:
$${x}^{opt} = arg [ {max}_{x} ( \frac{{x}^{T} Cx}{{x}^{T} D x} ) ] \qquad ( 14 )$$
and
determining, through a matrix C and a matrix D, a corresponding maximum eigenvalue λₘₐₓ and a corresponding eigenvector through a formula (15) as follows:
$$C {x}^{opt} = {λ}_{max} D {x}^{opt} \qquad ( 15 )$$
wherein in the formula (15), the maximum beam collection efficiency is equal to λₘₐₓ, and a corresponding optimal aperture-field amplitude distribution is ƒ(ρ)=(x^{opt})^{T}A.

6. The modular design method for the active phased array transmitting antenna for microwave wireless power transmission as claimed in claim 5, wherein, in step S14, the peak radiation level outside the receiving region is expressed through a formula (16) as follows:
$$PRL = 20 {log}_{10} \frac{{max}_{u \geq {u}_{0}} \vert F ( u ) \vert}{{max}_{u} \vert F ( u ) \vert} \qquad ( 16 )$$
wherein in the formula (16), PRL represents the peak radiation level outside the receiving region;
wherein the aperture-field distribution design problem of the transmitting antenna is transformed through a formula (17) as follows:
$${min}_{x} . g ( x ) = - B C E ( x ) \qquad ( 17 )$$
$$s . t . PRL ( x ) \leq {C}_{0}$$
$$- 1 \leq {x}_{i} \leq 1 ( i = 1 , … , N )$$
wherein in the formula (17), C₀ represents a maximum allowable radiation level outside the receiving region; and
without the constraint of the peak radiation level outside the receiving region, maximizing the beam collection efficiency, and obtaining the corresponding optimal aperture-field amplitude distribution and the radiation pattern.

7. The modular design method for the active phased array transmitting antenna for microwave wireless power transmission as claimed in claim 6, wherein the step S15 comprises:
incorporating the constraint on the peak radiation level outside the receiving region directly into an objective function to transform into an unconstrained optimization problem through a formula (18) as follows:
$$f ( x ) = - B C E ( x ) + ℵ \cdot [ max ( 0 , PRL ( x ) - {C}_{0} ) ] \qquad ( 18 )$$
wherein in the formula (18), X represents a penalty parameter configured to control influence of a penalty term; and
suppressing the peak radiation level outside the receiving region and achieving the high beam collection efficiency.
